(19) United States
(12) Patent Application Publication
(10) Pub. No.: US 2024/0088483 A1
(43) Pub. Date: Mar. 14, 2024

(54) THERMALLY INSULATING MULTILAYER SHEET, METHOD OF MANUFACTURE, AND ARTICLES USING THE SAME

(71) Applicant: ROGERS CORPORATION, Chandler, AZ (US)

(72) Inventors: Max W. Kristy, Chicago, IL (US); Kenneth A. Mazich, Hinsdale, IL (US)

(21) Appl. No.: 18/272,140

(22) PCT Filed: Jan. 7, 2022
(86) PCT No.: PCT/US2022/011533

§ 371 Date: Jul. 13, 2023

Related U.S. Application Data
(60) Provisional application No. 63/137,838, filed on Jan. 15, 2021.

(51) Int. Cl. H01M 10/658; B32B 5/18; B32B 25/04; B32B 25/16; B32B 25/18; C08J 5/12; C08J 9/36; F16L 59/02

(52) U.S. Cl. CPC H01M 10/658; B32B 5/18; B32B 25/045; B32B 25/16; B32B 25/18; C08J 5/124; C08J 9/365; F16L 59/029; B32B 2255/102; B32B 2255/20; B32B 2255/26; B32B 2266/0214; B32B 2266/0278; B32B 2307/302; B32B 2307/304; B32B 2307/3065; B32B 2307/54; B32B 2307/72; B32B 2307/726; B32B 2307/7376; B32B 2457/10; C08J 2311/00; C08J 2375/04; C08J 2383/04; C08J 2433/04; C08J 2483/04

(57) ABSTRACT

A thermally insulating multilayer sheet for preventing thermal runaway includes a nonporous elastomeric barrier layer having a first and a second opposed surface; a flexible foam layer disposed on the first surface of the barrier layer; and a flame retardant component, wherein the flame retardant component is distributed within the flexible foam layer, contacts a surface of the flexible foam layer, or both.

### CROSS REFERENCE TO RELATED APPLICATIONS

This application claims the benefit of U.S. Application No. 63/137,838, filed on Jan. 15, 2021, which is incorporated herein by reference in its entirety.

### BACKGROUND

This application is directed to a thermally insulating multilayer sheet for use in batteries, particularly for delaying or preventing thermal runaway in batteries. The application is further directed to methods for the manufacture of the thermally insulating multilayer sheets, and battery components and batteries including the thermally insulating multilayer sheets.

The demand for electrochemical energy storage devices, such as lithium-ion batteries, is ever increasing due to the growth of applications such as electric vehicles and grid energy storage systems, as well as other multi-cell battery applications, such as electric bikes, uninterrupted power battery systems, and replacements for lead acid batteries. Due to their increasing use, methods for heat management are desired. For large format applications, such as grid storage and electric vehicles, multiple electrochemical cells connected in series and parallel arrays are often used, which can lead to thermal runaway. Once a cell is in thermal runaway mode, the heat produced by the cell can induce a thermal runaway propagation reaction in adjacent cells, with the potential to cause a cascading effect that can ignite the entire battery.

While attempts to reduce thermal runaway of batteries have been considered, many have drawbacks. For example, modifying the electrolyte by adding flame retardant additives, or using inherently non-flammable electrolytes have been considered, but these approaches can negatively impact the electrochemical performance of the lithium ion cell. Other approaches for heat management or to prevent cascading thermal runaway include incorporating an increased amount of insulation between cells or clusters of cells to reduce the amount of thermal heat transfer during a thermal event. However, these approaches can limit the upper bounds of the energy density that can be achieved.

With the increasing demand for batteries with improved heat management or reduced risk of thermal runaway, there is accordingly a need for methods and components for use in batteries that prevents or delays the spread of heat, energy, or both to surrounding cells.

### BRIEF SUMMARY

In an aspect a thermally insulating multilayer sheet for preventing thermal runaway includes a nonporous elastomeric barrier layer having a first and a second opposed surface; a flexible foam layer disposed on the first surface of the barrier layer; and a flame retardant component, wherein the flame retardant component is distributed within the flexible foam layer, contacts a surface of the flexible foam layer, or both.

Electrochemical cells, unconnected arrays, and batteries including the above-described thermally insulating multilayer sheet are also described.

The above-described and other features are exemplified by the following figures, detailed description, examples, and claims.

### BRIEF DESCRIPTION OF THE DRAWINGS

The following is a brief description of the drawings, which are presented for the purpose of illustrating the exemplary embodiments disclosed herein and not for the purpose of limiting the same.

FIG. 1A is a schematic illustration of a pouch cell with a thermally insulating multilayer sheet adhered to an exterior of the pouch cell; FIG. 1B is a schematic illustration of an electrochemical cell and another aspect of a thermally insulating multilayer sheet;

FIG. 2 is an illustration of an aspect of a thermally insulating multilayer sheet located in between two cells;

FIG. 3 is an illustration of an aspect of a thermally insulating multilayer sheet located in between two cells;

FIG. 4 is an illustration of an aspect of a thermally insulating multilayer sheet located in between an array of cells;

FIG. 5 is an illustration of an aspect of a battery including the thermally insulating multilayer sheet;

FIG. 6 is a schematic, cross-sectional illustration of an aspect of a flame retardant component distributed within a flexible foam layer;

FIG. 7 is a schematic of an apparatus for a hot plate test; and

FIG. 8 is a graph of temperature (° C.) versus time (minutes (min)) showing results of simulated thermal runaway testing of Examples 1-3.

### DETAILED DESCRIPTION

Preventing thermal runaway in batteries, especially batteries that include a large plurality of electrochemical cells, is a difficult problem, as a cell adjacent to a cell experiencing a thermal runaway can absorb enough energy from the event to cause it to rise above its designed operating temperatures, triggering the adjacent cells to also enter into thermal runaway. This propagation of an initiated thermal runaway event can result in a chain reaction in which cells enter into a cascading series of thermal runaways, as the cells ignite adjacent cells. In order to prevent such cascading thermal runaway events from occurring, a thermally insulating multilayer sheet can be used. It has been particularly difficult, however, to achieve effective thermal runaway properties in very thin multilayer sheets, for example sheets that have a total thickness of 30 millimeters (mm) or less, or 20 mm or less, or 15 mm or less, or 10 mm or less, or 8 mm or less, or 6 mm or less. Thin multilayer sheets are increasingly desired to reduce article size and weight, and to conserve material.

The thermally insulating multilayer sheet for preventing thermal runaway in a battery includes a nonporous elastomeric barrier layer having a first and a second opposed surface; a flexible foam layer disposed on the first surface of the barrier layer; and a flame retardant component, wherein the flame retardant component is distributed within the flexible foam layer, contacts a surface of the flexible foam layer, or both. It has unexpectedly been found that use of a solid, nonporous elastomeric barrier layer that has low water vapor transmission is especially useful in the manufacture of multilayer sheets that are very thin, i.e., 30 mm or less, or 20 mm or less, or 15 mm or less, or 10 mm or less, or 8 mm or less, or 6 mm or less, and that have good thermal insulation properties. The thermally insulating multilayer sheet can have additional advantageous properties, for example good puncture resistance. The thermally insulating multilayer sheet can be subjected to multiple heating and cooling cycles, and still provide good thermal insulation. The thermally insulating multilayer sheet can further provide pressure management to the electrochemical cells and batteries. The thermal barrier provided by the thermally insulating multilayer sheet can be used in various sites in batteries to prevent thermal runaway. The thermally insulating multilayer sheet can further improve the flame resistance of batteries.

The thermally insulating multilayer sheet can have a thermal conductivity of 0.01 to 0.09 watts per meter kelvin (W/m*K) at 23° C.; a thickness of 0.2 to 30 mm, or 0.2 to 20 mm, or 0.2 to 15 mm, or 0.2 to 10 mm, or 0.5 to 10 mm, or 0.5 to 8 mm, or 1 to 6 mm; or a density of 6 to 30 pounds per cubic foot (lb/ft³) (96 to 481 kilograms per cubic meter (kg/m 3)), 10 to 25 lb/ft³ (160 to 400 kg/m 3), or 15 to 20 lb/ft³ (240 to 320 kg/m 3); or a combination thereof.

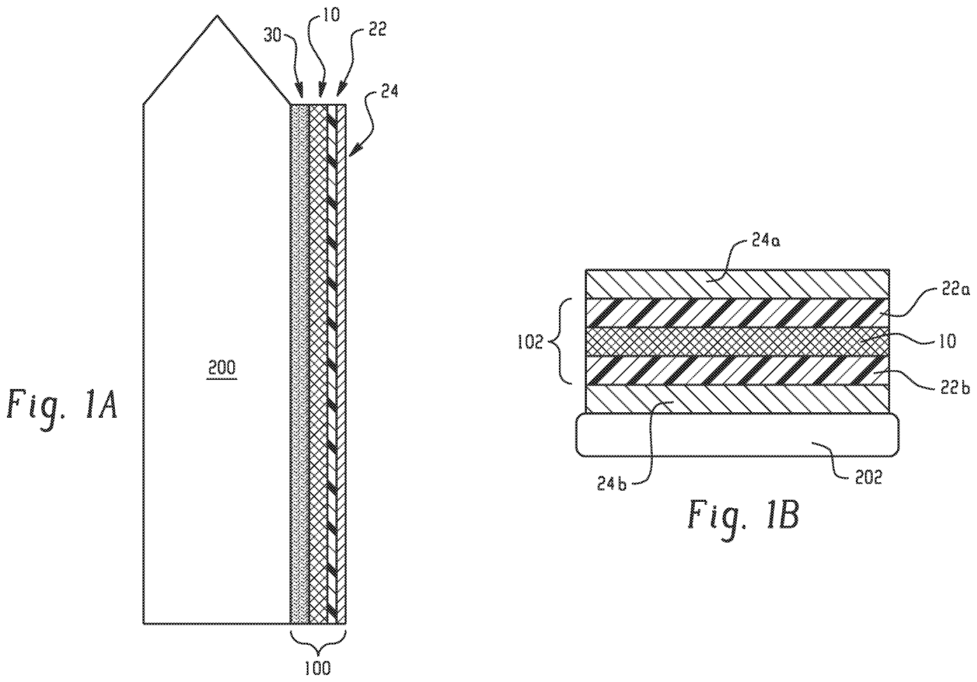

As illustrated in FIG. 1, the thermally insulating multilayer sheet 100 can be directly placed on or adhered to the exterior surface of a pre-formed battery cell, for example, on the exterior surface of a pouch cell 200. As shown, a nonporous elastomeric barrier layer 10 is disposed on the pouch cell 200, a flexible foam layer 22 is disposed on the nonporous elastomeric barrier layer 10, and the flame retardant component is a flame retardant layer 24 contacting a surface of the flexible foam layer 22. Preferably, the elastomeric barrier layer 10 is not simply a coating adhered to a surface of the foam that follows the contours of the foam, but has a thickness sufficient to provide a smooth outer surface.

In an aspect as shown in FIG. 1, the flame retardant layer 24 contacts an outer surface of the flexible foam layer 22. Alternatively, or in addition, the flame retardant layer can contact an inner surface of a pore within the flexible foam layer. For example, the flame retardant layer 24 can be coated onto a surface of the flexible foam layer 22. Such coating can result in the pores being filled (i.e., fully impregnated) or partially coated with the flame retardant layer. Preferably the inner surfaces of the pores are coated with an amount of the flame retardant component effective to maintain empty pore volume, so as to provide pressure management. In an aspect, a portion of the pores can be completed filled with the flame retardant layer. In another aspect, the flame retardant layer contacts the inner surface of only a portion of the pores, for example a portion of the pores adjacent the flame retardant layer 24. In the foregoing aspects, the flame retardant layer can be continuous or discontinuous. Preferably, the flame retardant layer is continuous, and is present at least on an outer surface of flexible foam layer 22.

The thermally insulating multilayer sheet 100 can be attached to pouch cell 200 by an adhesive layer. Further as shown in FIG. 1A, an adhesive layer 30 is disposed between the pouch cell and the nonporous elastomeric barrier layer 10. In an aspect the adhesive is not present, and the flexible foam layer can be disposed directly on the cell, for example pouch cell 200. Optionally, one or more adhesive layers can be disposed between each individual layer. Multiple adhesive layers can be present. Each of these layers is described in further detail below.

Without being bound by theory, it is believed that excellent results are provided due to different mechanisms working in concert. First, each of the flexible foam and flame retardant layers provides a barrier to heat conduction. Heat is further absorbed due to the heat capacity of the flame retardant layer and the heat of water vapor production from the flame retardant layer. However, water vapor production results in increased heat convection through the flexible foam layer. The nonporous elastomeric barrier layer blocks the water vapor and hot gasses, thereby providing improved thermal resistance to the thermally insulating multilayer sheet. In particular, water vapor produced on the heated surface of the thermally insulating multilayer sheet is constrained by the nonporous elastomeric barrier layer.

In an aspect, more than one nonporous elastomeric barrier layer, flexible foam layer, or flame retardant layer can be present. For example, FIG. 1B shows first flame retardant layer 24a disposed directed on first flexible foam layer 22a, which is disposed on nonporous elastomeric barrier layer 10. Further second flame retardant layer 24b is disposed directed on second flexible foam layer 22b, which is disposed on the nonporous elastomeric barrier layer 10, opposite the first flexible foam layer 22a and the first flame retardant layer 24a. The thermally insulating multilayer sheet 102 is disposed on cell 202. Each flexible foam layer and each flame retardant layer can be the same or different. Again, one or more adhesive layers can be present between each layer or between a layer and the electrochemical cell. As in other aspects, one or more adhesive layers can be present between any two layers or between a layer and the electrochemical cell.

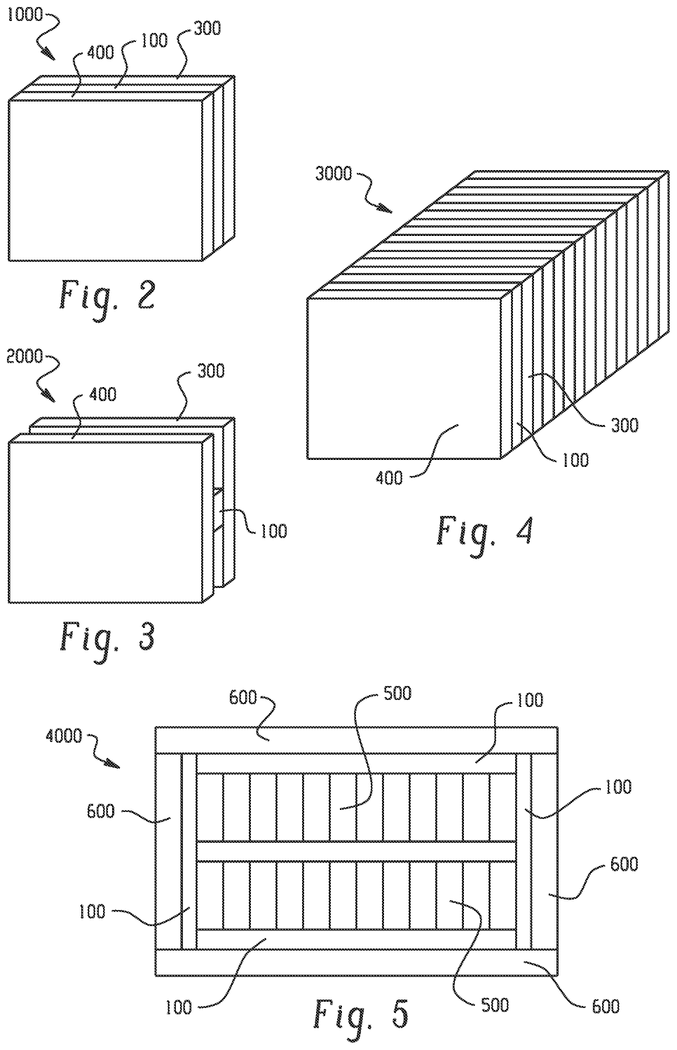

FIG. 2 illustrates a non-limiting example of the positioning of the thermally insulating multilayer sheet in a multi-cell arrangement 1000. FIG. 3 illustrates a non-limiting example of the positioning of the thermally insulating multilayer sheet in a multi-cell arrangement 2000, and FIG. 4 illustrates a non-limiting example of the positioning of the thermally insulating multilayer sheet in a multi-cell arrangement 3000. FIG. 2 and FIG. 3 illustrate that the thermally insulating multilayer sheet 100 can be located in between a first cell 300 and a second cell 400. FIG. 2 illustrates that the thermally insulating multilayer sheet 100 can be approximately the same size as the height and width of the cells 300, 400. FIG. 3 illustrates that the thermally insulating multilayer sheet 100 can be smaller than the respective cells 300, 400.

FIG. 4 illustrates that multi-cell arrangement 3000 can include more than two cells (e.g., 300, 400) with thermally insulating multilayer sheet 100 located in between the respective cells 300, 400. The cells can be lithium-ion cells, in particular pouch cells.

In an aspect, two to ten thermally insulating multilayer sheets can be disposed on/in a cell during manufacture of the cell. For example, two to ten thermally insulating multilayer sheets can be disposed on the interior, e.g., facing the electrodes, or exterior, facing outside of the battery. For example, two to ten thermally insulating multilayer sheets can be disposed on (adhesive facing out) or adhered to a pouch cell, or both. In an aspect, as illustrated in FIG. 5, the thermally insulating multilayer sheet 100 can provide pressure or thermal management in a battery 4000. For example, a battery 4000 can contain a plurality of unconnected arrays 500 inside a housing or cell carrier 600. As used herein, the phrase “unconnected array” refers to a group of cells not connected to terminals of a battery. The thermally insulating multilayer sheet 100 can be placed between individual cells in the unconnected array. The thermally insulating multilayer sheet 100 can be placed, adhered, or a combination thereof at the top, in between, below, adjacent, or a combination thereof the sides of unconnected array 500, a portion thereof, or a selected cell of unconnected arrays in the battery 4000. The thermally insulating multilayer sheet 100 can be placed, adhered, or a combination thereof beneath the battery 4000, a portion of each cell or unconnected array, or a selected set of cells or unconnected arrays. Placement or adhesion on one or more of the sides, which include the front or back, are also possible. Again, the thermally insulating multilayer sheet 100 can be placed, adhered, or a combination thereof on a portion or the entirety of the one or more sides.

In an aspect, a battery includes a battery case housing one or more cells or unconnected arrays. The thermally insulating multilayer sheet can be placed between individual cells or unconnected arrays in the battery. The thermally insulating multilayer sheet can be placed at the top, in between, below, adjacent, or a combination thereof the sides of the cells or unconnected arrays in the battery, a portion thereof, or a selected set of cells or unconnected arrays in the battery. The thermally insulating multilayer sheet, for example, with no exposed adhesive, can be placed or adhered to a plurality of pouch cells, pressure management pads, cooling plates, or other interior battery components. The assembly pressure of the battery can hold stacked components into place.

The thermally insulating multilayer sheet can be used in a battery that includes an unconnected array, i.e., a plurality of electrochemical cells. Cells include prismatic cells, pouch cells, cylindrical cells, and the like.

The individual layers and components of thermally insulating multilayer sheet 100 will be described next.

### Nonporous Elastomeric Barrier Layer

The nonporous elastomeric barrier layer is configured to delay or prevent thermal runaway, particularly in very thin multilayer constructions. The nonporous elastomeric barrier layer comprises an elastomer having a permeability coefficient for water of less than 20 g-mm per m² per day, or less than 10 g-mm per m² per day, or less than 5 g-mm per m² per day, each measured at 25° C. and 1 atmosphere; or a tensile stress at 100% elongation of 0.5 to 15 megaPascals measured at 21° C. in accordance with ASTM 412; or a combination thereof. The nonporous elastomeric barrier layer can have a thickness of 0.25 to 1 mm or 0.4 to 0.8 mm.

The nonporous elastomeric barrier layer can include an elastomeric material that is hydrophobic, to prevent water or water vapor transmission. For example, the elastomeric barrier layer can include a thermoplastic elastomer (TPE), provided that it has the preferred hydrophobicity (lack of water or water vapor transmission). Classes of TPEs include styrenic block copolymers (TPS or TPE-s), (TPO or TPE-o), thermoplastic vulcanizates (TPV or TPE-v), thermoplastic polyurethane, thermoplastic copolyesters (TPC or TPE-E), thermoplastic polyamides (TPA or TPE-A), and others.

Specific examples of elastomeric materials that can the preferred hydrophobicity (lack of water or water vapor transmission) include an acrylic rubber, butyl rubber, halogenated butyl rubber, copolyester, epichlorohydrin rubber, ethylene-acrylic rubber, ethylene-butyl acrylic rubber, ethylene-diene rubber (EPR) such as ethylene-propylene rubber, ethylene-propylene-diene monomer rubber (EPDM), ethylene-vinyl acetate, fluoroelastomer, perfluoroelastomer, polyamide, polybutadiene, polychloroprene, polyolefin rubber, polyisoprene, polysulfide rubber, natural rubber, nitrile rubber, low density polyethylene, polypropylene, thermoplastic polyurethane elastomer (TPU), silicone rubber, fluorinated silicone rubber, styrene-butadiene, styrene-isoprene, vinyl rubber, or a combination thereof. In an aspect the barrier layer comprises ethylene-propylene-diene monomer rubber, polychloroprene, or a combination thereof.

### Flexible Foam Layer

The flexible foam layer provides pressure management and can be a low density, cellular material that allows for the expansion of the cell. The flexible foam layer can also have good compression set resistance and minimal stress relaxation, preferably less than 10% compression and force retention of greater than 50%. The flexible foam layer can be thermally conductive. For example, the flexible foam layer can have a low thermal conductivity (Tc), for example a Tc of 0.01 to 0.5 W/m*K at 23° C., or 0.01 to 0.09 W/m*K at 23° C. The flexible foam layer can be a polymer foam or a flexible aerogel.

In an aspect, each flexible foam layer independently has a compression force deflection of 0.2 to 125 pounds per square inch (psi) (1 to 862 kilopascals (kPa)), or 0.25 to 20 psi (1.7 to 138 kPa), or 0.5 to 10 psi (3.4 to 68.90.5 kPa), each at 25% deflection and determined in accordance with ASTM D3574-17; a compression set of 0 to 15%, or 0 to 10%, or 0 to 5%, determined in accordance with ASTM D 3574-95 Test D at 70° C.; or a density of 5 to 65 lb/ft³ (80 to 1,041 kg/m 3), or 6 to 20 lb/ft³ (96 to 320 kg/m 3), or 8 to 15 lb/ft³ (128 to 240 kg/m 3).

Each flexible foam layer can independently have a thickness of 0.1 to 5 mm, 1 to 3 mm, or 1.5 to 2.5 mm. Each flexible foam layer can independently be a silicone, a polyurethane, an aerogel, an ethylene-vinyl acetate (EVA), an ethylene-methyl acrylate (EMA), an ethylene-butyl acrylate (EBA), or a combination thereof. Exemplary flexible foam layers can include a polymer foam such as a polyurethane foam or a silicone foam, or an elastomeric polymer such as vinyl acetate (EVA), thermoplastic elastomers (TPE), EPM (ethylene-propylene rubber), or an EPDM (ethylene-propylene-diene monomer) rubber. For example, the flexible foam layer can include, for example, a PORON® polyurethane foam or a BISCO® silicone foam that have reliable compression set resistance (c-set) and stress relaxation performance over a broad range of temperatures.

As used herein, “foams” refers to materials having a permanent, for example a thermoset, cellular structure. The foams are flexible, as opposed to rigid. Exemplary foams for use in the flexible foam layer have densities lower than 65 lb/ft³ (1,041 kg/m 3), preferably less than or equal to 55 lb/ft³ (881 kg/m 3), more preferably less than or equal to 25 lb/ft³ (400 kg/m 3), a void volume content of at least 5 to 99%, preferably greater than or equal to 30%, based upon the total volume of the foam, or a combination thereof. In an aspect, the foam has a density of 5 to 30 lb/ft³ (80 to 481 kg/m 3).

Polymers for use as the foams can be one or more of a wide variety of thermoplastics, blends of thermoplastics, or thermosetting resins. Examples of thermoplastics that can be used include polyacetals, polyacrylics, styrene-acrylonitrile, polyolefins, acrylonitrile-butadiene-styrene, polycarbonates, polystyrenes, esters such as polyethylene terephthalate and polybutylene terephthalate, polyamides such as Nylon 6, Nylon 6,6, Nylon 6,10, Nylon 6,12, Nylon 11 or Nylon 12, polyamideimides, polyarylates, polyurethanes, ethylene propylene rubbers (EPR), polyarylsulfones, polyethersulfones, polyphenylene sulfides, polyvinyl chlorides, polysulfones, polyetherimides, polytetrafluoroethylenes, fluorinated ethylene propylenes, polychlorotrifluoroethylenes, polyvinylidene fluorides, polyvinyl fluorides, polyetherketones, polyether etherketones, polyether ketone ketones, or the like.

Examples of blends of thermoplastic polymers that can be used in the polymer foams include acrylonitrile-butadiene-styrene/nylon, polycarbonate/acrylonitrile-butadiene-styrene, acrylonitrile butadiene styrene/polyvinyl chloride, polyphenylene ether/polystyrene, polyphenylene ether/nylon, polysulfone/acrylonitrile-butadiene-styrene, polycarbonate/thermoplastic urethane, polycarbonate/polyethylene terephthalate, polycarbonate/polybutylene terephthalate, thermoplastic elastomer alloys, polyethylene terephthalate/polybutylene terephthalate, styrene-maleic anhydride/acrylonitrile-butadiene-styrene, polyether etherketone/polyethersulfone, styrene-butadiene rubber, polyethylene/nylon, polyethylene/polyacetal, ethylene propylene rubber (EPR), and the like, or a combination thereof.

Examples of polymeric thermosetting resins that can be used in the polymer foams include polyurethanes, epoxies, phenolics, polyesters, polyamides, silicones, and the like, or a combination thereof. Blends of thermosetting resins as well as blends of thermoplastic resins with thermosetting resins can be used.

Silicone foams including a polysiloxane polymer can also be used. In an aspect, the silicone foams are produced as a result of the reaction between water and hydride groups in a polysiloxane polymer precursor composition with the consequent liberation of hydrogen gas. This reaction can be catalyzed by a noble metal, preferably a platinum catalyst. In an aspect, the polysiloxane polymer has a viscosity of 100 to 1,000,000 poise at 25° C. and has chain substituents such as hydride, methyl, ethyl, propyl, vinyl, phenyl, and trifluoropropyl. The end groups on the polysiloxane polymer can be hydride, hydroxyl, vinyl, vinyl diorganosiloxy, alkoxy, acyloxy, allyl, oxime, aminoxy, isopropenoxy, epoxy, mercapto groups, or other reactive end groups. Silicone foams can also be produced by using several polysiloxane polymers, each having different molecular weights (e.g., bimodal or trimodal molecular weight distributions) as long as the viscosity of the combination lies within the specified values. It is also possible to have several polysiloxane base polymers with different functional or reactive groups in order to produce the desired foam. In an aspect, the polysiloxane polymer includes 0.2 moles of hydride (Si—H) groups per mole of water.

Depending upon the chemistry of the polysiloxane polymers used, a catalyst, for example, platinum or a platinum-containing catalyst, can be used to catalyze the blowing and the curing reaction. The catalyst can be deposited onto an inert carrier, such as silica gel, alumina, or carbon black. In an aspect, an unsupported catalyst can be chloroplatinic acid, its hexahydrate form, its alkali metal salts, and its complexes with organic derivatives is used.

Certain aerogels can be used as the flexible foam layer. An aerogel is an open-celled solid matrix including a network of interconnected nanostructures with a porosity of greater than 50 volume percent (vol %), more preferably greater than 90 vol %. Aerogels can be derived from a gel by replacing the liquid component in the gel with a gas, or by drying a wet gel, such as by supercritical drying. Exemplary aerogels include polymer aerogels such as poly(vinyl alcohol), polyurea, polyurethane, polyimide, a resorcinol-formaldehyde polymer, polyisocyanate, epoxy, and polyacrylamide aerogels; polysaccharide aerogels including chitin and chitosan aerogels; and inorganic aerogels, for example carbon (e.g., graphene) aerogels, ceramic aerogels (e.g., boron nitride aerogels), and a metal oxide and metalloid oxide aerogels (e.g., aluminum oxide, vanadium oxide, and silica aerogels). A combination of the foregoing materials can be used, for example a silica aerogel crosslinked by an organic diisocyanate.

The aerogel can have a compression force deflection of 0.2 to 150 psi (1.4 to 1,034 kPa), preferably 2 to 25 psi (13.8 to 172 kPa), each at 25% deflection, determined in accordance with ASTM D3574-17. A density of the aerogel can be 1 to 20 lb/ft³ (16 to 320 kg/m 3), preferably 2 to 15 lb/ft³ (32 to 240 kg/m 3), more preferably 2 to 10 lb/ft³ (32 to 160 kg/m 3). A thickness of the aerogel can be 0.5 to 10 mm, preferably 1 to 6 mm, more preferably 1 to 3 mm.

In an aspect, the aerogel can be a silica aerogel including reinforcing fibers. The reinforcing fibers can include polyester, oxidized polyacrylonitrile, carbon, silica, polyaramid, polycarbonate, polyolefin, rayon, nylon, fiberglass, high density polyolefin, ceramics, acrylics, fluoropolymer, polyurethane, polyamide, polyimide, or a combination thereof.

An optional additive can be present in the elastomeric polymer, the polymer foam, or the aerogel. For example, the additive can include a reinforcing material such as a reinforcing particulate material or a reinforcing fiber material. Exemplary reinforcing particulate materials include lignin, carbon black, talc, mica, silica, quartz, metal oxide, glass microspheres, polyhedral oligomeric silsesquioxane, substituted polyhedral oligomeric silsesquioxane, or a combination thereof. Exemplary reinforcing fiber materials include fiber materials wherein fibers of the reinforcing fiber material include polyester, oxidized polyacrylonitrile, carbon, silica, polyaramid, polycarbonate, polyolefin, rayon, nylon, fiberglass, high density polyolefin, ceramic, acrylics, fluoropolymer, polyurethane, polyamide, polyimide, or a combination thereof where the fibers can be in any form, such as a woven or nonwoven mat. A combination the reinforcing particulate material and reinforcing fiber material can be used. The additive can include a filler (for example, calcium carbonate or clay), dye, pigment (for example, titanium dioxide or iron oxide), antioxidant, antiozonant, ultraviolet light stabilizer, a thermally conductive particulate material (for example boron nitride or alumina), or an electrically conductive filler (for example a particulate electrically conductive polymer). A combination of additives can be used.

Exemplary fiberglass can be woven or non-woven, such as a felt. The fiberglass can comprise, for example, E glass fibers, S glass fibers, D glass fibers, L glass fibers, quartz fibers, or a combination thereof. The fiberglass can have a thickness of, for example, 0.005 to 10 mm, 0.05 to 5 mm, 0.25 to 3 mm, 0.005 to 0.05 mm, 0.05 to 0.5 mm, 0.5 to 3 mm, 0.25 to 10 mm, 0.5 to 5 mm, or 1 to 3 mm. The fiberglass can optionally be impregnated or coated with a thermoset or thermoplastic polymer. Exemplary thermoset polymers include epoxies, polyesters, and vinylesters.

Exemplary microspheres include cenospheres, glass microspheres, for example borosilicate microspheres, or a combination thereof. The microspheres are hollow spheres having a mean diameter of less than 300 micrometers (μm), for example, 15 to 200 μm, or 20 to 100 μm. The density of the hollow microspheres can range from 0.1 grams per cubic centimeter (g/cc) or greater, for example, 0.2 to 0.6 g/cc, or 0.3 to 0.5 g/cc.

Hollow microspheres are available from a number of commercial sources, for example, from Trelleborg Offshore (Boston), formerly Emerson and Cuming, Inc., W.R. Grace and Company (Canton, MA), and 3M Company (St. Paul, MN). Such hollow microspheres are referred to as microballoons, glass bubbles, microbubbles, or the like and are sold in various grades, for example, which can vary according to density, size, coatings, surface treatments, or a combination thereof.

For example, microspheres can have an exterior surface chemically modified by treatment with a coupling agent that can react with hydroxyl groups present on the surface of the glass. In an aspect, the coupling agent is a silane or epoxy, for example, an organosilane having, at one end, a group that can react with hydroxyl groups present on the exterior surface of the glass microspheres and, on the other end, an organic group that will aid in dispersibility of the microspheres in a polymer matrix that has low polarity. A difunctional silane coupling can have a combination of groups selected from vinyl, hydroxy, and amino groups, for example, 3-amino-propyltriethoxy silane. Silane coatings can also minimize water absorption.

The borosilicate microspheres can be made of alkali borosilicate glass. An exemplary oxide composition of alkali borosilicate can include 76.6 weight percent (wt %) SiO₂, 21.3 wt % Na₂O, 1.9 wt % B₂O₃, and 0.2 wt % other components. An exemplary soda-lime borosilicate can include 80.7 wt % SiO₂, 6.9 wt % Na₂O, 10.3 wt % CaO, 2.1 wt % B₂O₃, and 1.9 wt % of impurities. Thus, the composition (although mostly SiO₂ and including at least 1 percent B₂O₃) can vary to some extent, depending on the starting materials.

The size of the microspheres and their size distribution can vary. In an exemplary aspect, the borosilicate microspheres exhibit a mean particle diameter of 20 to 100 micrometer (μm), for example, 20 to 75 μm, 25 to 70 μm, 30 to 65 μm, 35 to 60 μm, or 40 to 55 μm. The size distribution can be bimodal, trimodal, or the like.

Reinforcing particulate materials can include polyhedral oligomeric silsesquioxane (commonly referred to as “POSS,” also referred to herein as the “silsesquioxane”), substituted polyhedral oligomeric silsesquioxane, or a combination thereof. The inclusion of a silsesquioxane can have the added benefit of improving the durability of the flexible foam layer in oxidizing environments. The silsesquioxane is a nano-sized inorganic material with a silica core that can have reactive functional groups on the surface. The silsesquioxane can have a cube or a cube-like structure comprising silicon atoms at the vertices and interconnecting oxygen atoms. Each of the silicon atoms can be covalently bonded to a pendent R group. The silsesquioxane of the formula (I) (R₈Si₈O₁₂) comprises a cage of silicon and oxygen atoms around a core with eight pendent R groups.

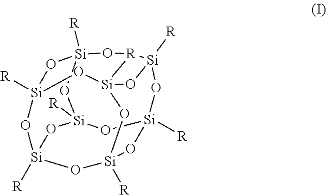

The silsesquioxane can be substituted or unsubstituted, such that each R group independently can be a hydrogen, a hydroxy group, an alkyl group, an aryl group, or an alkenyl group, where the R group can comprise one to twelve carbon atoms and one or more heteroatoms (for example, at least one of oxygen, nitrogen, phosphorus, silicon, or a halogen). Each R group independently can include one or more reactive groups such as at least one of an alcohol, an epoxy group, an ester, an amine, a ketone, an ether, a halide, or a combination thereof. Each R group independently can comprise at least one of a silanol, an alkoxide, or a chloride. An example of a silsesquioxane is octa(dimethylsiloxy) silsesquioxane.

The flexible foam layer, for example, a silicone flexible foam layer can be immersed in a solvent, for example, water, for a period of time, for example, 24 hours, to imbibe water into the silicone flexible foam layer. The high heat capacity of liquid water can contribute to significantly delaying heat transfer from one surface of the flexible foam layer to the other surface of the flexible foam layer.

### Flame Retardant Component

The flame retardant component can include an intumescent material, a flame retardant inorganic material such as boehmite, aluminum hydroxide, magnesium hydroxide, or the like, as further described below, or a combination thereof. As described above, the flame retardant component can be present as a flame retardant layer contacting a surface of the flexible foam. Each flame retardant layer can have a thickness of 0.1 to 2 mm, or 0.5 to 1.5 mm, or 0.8 to 1.1 mm, particularly when contacting an outer surface of the flexible foam layer. A flame retardant layer contacting an inner surface of a pore can be thinner, for example 0.01 to 1 mm, 0.01 to 0.8 mm, or 0.01 to 0.8 mm.

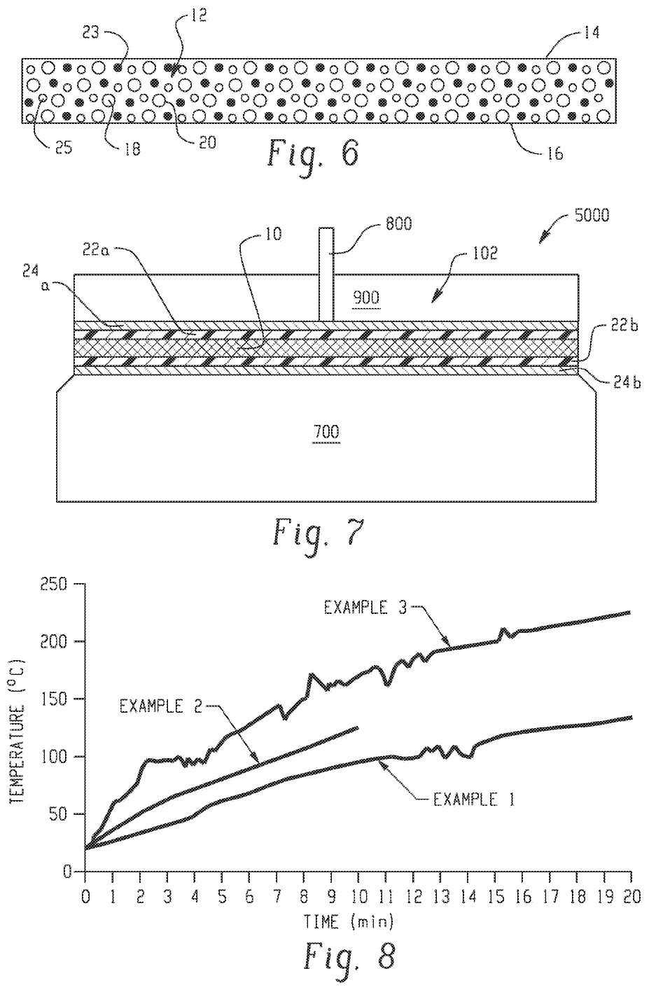

Alternatively, or in addition, the flame retardant component can be a flame retardant material distributed within the matrix of the flexible foam layer itself. FIG. 6 illustrates an aspect of a flame retardant component distributed within the matrix of a flexible foam layer 12. The flexible foam layer 12 has a first outer surface 14 and an opposite second outer surface 16. Although shown as flat, one or both or all of the outer surfaces can be contoured to provide better fit with a surface of an electrochemical cell.

Flexible foam layer 12 further includes a plurality of pores 18. The pores are defined by an inner surface 20 of the pores in the polymer foam matrix. The pores can be interconnected or discrete. A combination of interconnected and discrete pores can be present. The pores can be wholly contained within the sheet, or at least a portion of the pores can be open, allowing communication with the surrounding environment. In an aspect, at least a portion of the pores are interconnected and at least a portion of the pores are open, allowing passage of air, water, water vapor, or the like from first outer surface 14 to the opposite second outer surface 16, referred to herein as an “open-celled foam”. In another aspect, the pores do not interconnect, and do not allow allowing passage of air, water, water vapor, or the like from one outer surface to the other outer surface.

With further reference to FIG. 6, flame retardant component can comprise two or more different flame retardant components 23, 25 distributed within the matrix of flexible foam layer 12. The flame retardant components can be distributed essentially uniformly, or as a gradient, for example increasing from a first outer surface 14 in the direction of second outer surface 16. As shown in FIG. 6, the flame retardant component can be distributed within the flexible foam layer matrix in particulate form. The flame retardant component in particulate form can allow easy incorporation into the flexible foam layer during manufacture thereof.

Alternatively, or in addition, the flame retardant component in particulate form can be in within a pore of the flexible foam layer. A portion of the number of pores in the flexible foam layer can contain the particulate flame retardant component, or essentially all, or all of the pores can contain the particulate flame retardant component. Each pore containing the particulate flame retardant component can independently be partially filled, essentially fully filled, or fully filled. In aspects where the particulate flame retardant particles are large relative to the diameter of the pore, or the pore is essentially or fully filled with a plurality of smaller particles, movement of the flame retardant particles within the pore can be restricted. In this aspect, the particulate flame retardant component can be located in the pores during manufacture of the layer (for example, by including the particulate flame retardant component in the composition used to form the flexible foam layer), or the particulate flame retardant component can be impregnated into the pores after manufacture of the flexible foam layer using a suitable liquid carrier, vacuum, or other known method.

A combination of different flame retardant components, including different types, forms, or placements can be used. For example, a flame retardant layer can be used in combination with a flame retardant particulate material distributed within the flexible foam matrix; or a flame retardant layer can be used in combination with a particulate flame retardant component disposed within a pore of the flexible polymer layer. In an aspect, a flame retardant intumescent layer in combination with flame retardant particulate material distributed within the flexible foam matrix is used. In a preferred aspect, a flame retardant intumescent layer is used alone, for ease of manufacture and to maintain the desired thinness and flexibility of the flexible polymer foam.

The intumescent material can include an acid source, a blowing agent, and a carbon source. Each component can be present in separate layers or as an admixture, preferably an intimate admixture. For example, the intumescent material can include a polyphosphate acid source, a blowing agent, and a pentaerythritol carbon source. Without being bound by theory, it is believed that the intumescent material can reduce the spread of flames using two energy absorbing mechanisms, including forming a char and then swelling the char. For example, as the temperature reaches a value, for example, of 200 to 280° C., the acidic species (for example, of the polyphosphate acid) can react with the carbon source (for example, pentaerythritol) to form a char. As the temperature increases, for example, to 280 to 350° C., the blowing agent can then decompose to yield gaseous products that cause the char to swell.

The acid source can include, for example, an organic or an inorganic phosphorous compound, an organic or inorganic sulfate (for example, ammonium sulfate), or a combination thereof. The organic or inorganic phosphorous compound can include an organophosphate or organophosphonate (for example, tris(2,3-dibromopropyl)phosphate, tris(2-chloroethyl)phosphate, tris(2,3-dichloropropyl)phosphate, tris(1-chloro-3-bromoisopropyl) phosphate, bis(1-chloro-3-bromoisopropyl)-1-chloro-3-bromoisopropyl phosphonate, polyaminotriazine phosphate, melamine phosphate, triphenyl phosphate, or guanylurea phosphate); an organophosphite ester (for example, trimethyl phosphite, or triphenyl phosphite); a phosphazene (for example, hexaphenoxycyclotriphosphazene); a phosphorus-containing inorganic compound (for example, phosphoric acid, phosphorus acid, a phosphite, urea phosphate, an ammonium phosphate (for example, ammonium monohydrogen phosphate, ammonium dihydrogen phosphate, or ammonium polyphosphate)); or a combination thereof.

The blowing agent can include an agent that decomposes (for example, into smaller compounds such as ammonia or carbon dioxide) at a temperature of greater than or equal to 120° C., for example, at 120 to 200° C., or at 130 to 200° C. The blowing agent can include a dicyandiamide, an azodicarbonamide, a melamine, a guanidine, a glycine, a urea (for example, a urea-formaldehyde resin or a methylolated guanylurea phosphate), a halogenated organic material (for example, a chlorinated paraffin), or a combination thereof.

The intumescent material can include a carbon source. The flexible foam layer can function as the carbon source. The carbon source can include dextrin, a phenol-formaldehyde resin, pentaerythritol (for example, a dimer or trimer thereof), a clay, a polymer (for example, polyamide 6, an amino-poly(imidazoline-amid), or polyurethane), or a combination thereof. The amino-poly(imidazoline-amid) can include repeating amide linkages and imidazoline groups.

The intumescent material can optionally further include a binder. The binder can include an epoxy, a polysulfide, a polysiloxane, a polysilarylene, or a combination thereof. The binder can be present in the intumescent material in an amount of less than or equal to 50 wt %, or 5 to 50 wt %, or 35 to 45 wt %, based on the total weight of the intumescent material. The binder can be present in the intumescent material in an amount of 5 to 95 wt %, or 40 to 60 wt % based on the total weight of the intumescent material.

The intumescent material can optionally include a synergistic compound to further improve the flame retardance of the intumescent material. The synergistic compound can include a boron compound (e.g., zinc borate, boron phosphate, or boron oxide), a silicon compound, an aluminosilicate, a metal oxide (e.g., magnesium oxide, ferric oxide, or aluminum oxide hydrate (boehmite)), a metal salt (e.g., alkali metal or alkaline earth metal salts of organosulfonic acids or alkaline earth metal carbonates), or a combination thereof. Preferred synergistic combinations include phosphorus-containing compounds with at least one of the foregoing.

The flame retardant layer can further include a char-forming agent, preferably a lignin, boehmite, clay nanocomposite, expandable graphite, pentaerythritol, cellulose, nanosilica, ammonium polyphosphate, lignosulfonate, melamine, cyanurate, zinc borate, huntite, hydromagnesite, or a combination thereof. Without being bound by theory, similar to the intumescent material, it is believed that the char-forming agent can reduce the spread of flames using two energy absorbing mechanisms, including forming a char and then swelling the char.

The flame retardant component can include an organic flame retardant compound such as melamine, a triazine, a phosphonamidate, an aryl or alkyl phosphate, an aryl or alkyl phosphonate, an aryl or alkyl phosphinate, an aryl or alkyl phosphine or the corresponding oxide thereof, a phosphazene, or the like, or a combination thereof. In an aspect, a flame retardant compound including a halogen, e.g., bromine or chlorine, is not present. The flame retardant component can include an inorganic flame retardant such as aluminum hydroxide (which as used herein includes aluminum trihydrate and various hydrates of aluminum oxide), boehmite, borax (sodium tetraborate pentahydrate), hydrous sodium silicate, magnesium hydroxide, magnesium carbonate hydroxide pentahydrate, magnesium phosphate tribasic octahydrate, or zinc borate, preferably at least two of aluminum trihydrate, borax, hydrous sodium silicate, magnesium hydroxide, magnesium carbonate hydroxide pentahydrate, magnesium phosphate tribasic octahydrate, or zinc borate. For example, the flame retardant component can include aluminum trihydrate and zinc borate; or borax and hydrous sodium silicate; or aluminum trihydrate, zinc borate, and hydrous sodium silicate; or borax and zinc borate; or borax, zinc borate, and aluminum trihydrate.

In an aspect, an organic flame and an inorganic flame retardant is present in the flame retardant component, and in another aspect, only an inorganic flame retardant is present in the flame retardant component. Inorganic flame retardants are generally available in the form of particles. The particles can be of any shape, irregular or regular, for example approximately spherical, spherical, or plate-like. In an important feature, most, essentially all, or all, of the particles have a largest dimension less than the thickness of the layer or the pore in which they are located, to provide a smooth surface to the layer. The particular diameters used therefore depend on the location of the particles. Bi-, tri-, or higher multimodal distributions of particles can be used. For example, when flame retardant particles are present within the matrix of the flexible foam layer and within the pores of the flexible foam layer, a bimodal distribution of particles can be present.

As described above, the flame retardant component, for example an intumescent material, char forming agent, and flame retardant (preferably an inorganic flame retardant), can be in the form of a layer. The flame retardant layer can further include a polymer binder for the flame retardant component. Similar to the flexible foam layer, the polymer binder of the flame retardant layer can include, for example, a silicone, a polyurethane, an ethylene-vinyl acetate, an ethylene-methyl acrylate, an ethylene-butyl acrylate, or a combination thereof. Descriptions of such materials are not repeated. The amount of binder relative to the amount of the intumescent material, char forming agent, and flame retardant (preferably an inorganic flame retardant) can vary depending on factors such as the desired characteristics of the flame retardant layer and processability of the composition used to form the layer. For example, the binder can be present in an amount of 20 to 80 volume percent (vol. %), or an amount of 40 to 70 vol. %, each based on the total volume of the composition used to form the flame retardant layer.

In an aspect, the flame retardant component can be distributed within the matrix of the flexible foam layer. Preferably when a flame retardant component is distributed within the matrix of the flexible foam layer, a flame retardant layer as described above is also present, as it can be more challenging to achieve the desired flame retardant and foam properties using only the flexible foam layer and the nonporous elastomer layer. In this aspect, the flame retardant component can include an intumescent composition, a char-forming agent, organic flame retardant compound, an inorganic flame retardant, or a combination thereof, for example a combination of an organic and an inorganic flame retardant. Alternatively the flame retardant component distributed within the matrix of the flexible foam layer includes only an organic flame retardant. In another aspect, the flame retardant component includes only an inorganic flame retardant as described above. For example, the flame retardant component can include aluminum trihydrate, borax, hydrous sodium silicate, magnesium hydroxide, magnesium carbonate hydroxide pentahydrate, magnesium phosphate tribasic octahydrate, or zinc borate, as disclosed herein, distributed within the flexible foam layer.

The flame retardant component, for example the aluminum trihydrate, borax, hydrous sodium silicate, magnesium hydroxide, magnesium carbonate hydroxide pentahydrate, magnesium phosphate tribasic octahydrate, or zinc borate can be incorporated into a foam-forming composition of the flexible foam layer before the foam-forming composition is foamed and cured. The flame retardant component, for example the aluminum trihydrate, borax, hydrous sodium silicate, magnesium hydroxide, magnesium carbonate hydroxide pentahydrate, magnesium phosphate tribasic octahydrate, or zinc borate can be distributed essentially uniformly, or as a gradient, for example, increasing in a thickness direction of the flexible foam layer within which the flame retardant component is distributed.

The amount of the composition used to form the flexible foam layer relative to the amount of the intumescent material, char forming agent, and flame retardant (preferably an inorganic flame retardant) can vary depending on factors such as the desired characteristics of the flame retardant layer and processability of the composition used to form the layer. For example, when an inorganic flame retardant is present, the flame retardant component can be present in an amount of 10 to 90 volume percent (vol. %), or an amount of 20 to 80 vol. %, each based on the total volume of the composition used to form the flexible foam layer. When only an organic flame retardant or char-forming agent is present, the flame retardant component can be present in an amount of 0.1 to 15 weight percent (wt. %), or an amount of 1 to 10 wt. %, each based on the total weight of the composition used to form the flexible foam layer.

### Adhesive Layer

A wide variety of adhesives are known in the art can be used in the thermally insulating multilayer sheet. The adhesive can be selected for ease of application and stability under the operating conditions of the battery. Each adhesive layer can the same or different, and be of the same or different thickness. Suitable adhesives include a phenolic resin, an epoxy adhesive, a polyester adhesive, a polyvinyl fluoride adhesive, an acrylic or methacrylic adhesive, or a silicone adhesive, preferably an acrylic adhesive or a silicone adhesive. In an aspect, the adhesive is a silicone adhesive. Solvent-cast, hot-melt, and two-part adhesives can be used. Each of the adhesive layers can independently have a thickness of 0.00025 to 0.010 inches (0.006 to 0.25 mm), or 0.0005 to 0.003 inches (0.01 to 0.08 mm).

### Additional Layer

Additional layers can be present in the thermally insulating multilayer sheets to improve manufacturing, handling, performance, or other desired characteristics. For example, a support layer can be disposed on, or directly on the flexible foam layer to improve easy of handling. Such layers can be polymer layers, for example polyimide, polyetherimide, polyester (e.g., polybutylene terephthalate or polyethylene terephthalate), or the like.

When the thermally insulating multilayer sheet includes an adhesive layer, the thermally insulating multilayer sheet can further include a release layer. By “release layer” is meant any single or composite layer including a release coating, optionally supported by one or more additional layers including a release liner. The thickness of each of the release layers can be 5 to 150 μm, 10 to 125 μm, 20 to 100 μm, 40 to 85 μm, or 50 to 75 μm.

The thermally insulating multilayer sheets can be assembled by methods known in the art. The sheets can be assembled on a surface of a cell or other component of a battery (for example, a wall of a battery case). In an aspect, the sheet is assembled separately, and then placed or adhered to the cell, the component, or both. Each of the sheets can be manufactured separately, and then stacked (placed or adhered using, for example, one or more adhesive layers) in the desired order. Alternatively, one or more individual layers can be manufactured on another individual layer, for example by coating, casting, or laminating using heat and pressure. For example, in an aspect, the flexible foam layer can be directly cast onto the nonporous elastomeric barrier layer. Lamination and direct coating or casting can decrease thickness and improve flame retardance by eliminating an adhesive layer.

The thermally insulating multilayer sheets can be used in batteries, particularly lithium-ion batteries in a wide variety of fields, including electric vehicles, hybrid vehicles, grid energy storage systems and other multi-cell battery applications, such as uninterrupted power battery systems and replacements for lead acid batteries. “Vehicles” as used herein include automobiles, buses, motorcycles, scooters, bicycles, trains, ships, and the like. Other fields include electronic devices of all types, including hand-held devices.

As stated above, the thermally insulating multilayer sheets can be used where low weight or thickness is desired. Accordingly, in an embodiment, the thermally insulating multilayer sheet for preventing thermal runaway in a battery includes a nonporous elastomeric barrier layer having a first and a second opposed surface; a flexible foam layer disposed on the first surface of the barrier layer; and a flame retardant component, wherein the flame retardant component is distributed within the matrix of the flexible foam layer, contacts a surface of the flexible foam, or both, and wherein the thermally insulating multilayer sheet has a thickness of 30 mm or less, or 20 mm or less, or 15 mm or less, or 10 mm or less, or 8 mm or less, or 6 mm or less. In this aspect, the nonporous elastomeric barrier layer can be an ethylene-propylene-diene monomer rubber or a polychloroprene, and the flexible foam layer can be a silicone foam, a polyurethane foam, or an aerogel.

The following examples are provided to illustrate the present disclosure. The examples are merely illustrative and are not intended to limit devices made in accordance with the disclosure to the materials, conditions, or process parameters set forth therein.

### EXAMPLES

The materials listed in Table 1 were used in the examples.

TABLE 1

| Category | Description | Tradename | Manufacturer |
|---|---|---|---|
| Pyrogel | Thickness 2 mm; density 0.17 g/cm³; | Pyrogel | Aspen Aerogels |
| | CFD at 25% 104.9 kPa | 2250 | |
| Polyurethane | Thickness 3 mm; density 0.16 g/cm³, CFD at 25% 37.4 | 43-10080 | Rogers |
| flexible | kPa; compression set 70° C., 50%/22 hr 7.52%, 70° C., | | Corporation |
| foam layer | 50%/7 days 14.5% | | |
| Silicone flexible | Thickness 1.60 mm; density 0.043 g/cm³; CFD 68.95 kPa; | BISCO ® | Rogers |
| foam layer | compression set 100° C., 22 hr 3% | HT-800 | Corporation |
| Aluminum | Precipitated aluminum trihydrate; | Micral 855 | Huber |
| hydroxide | mean particle size 2 μm | | |
| Silicone | Vinyl terminated polydimethylsiloxane blended with | Binder A | Rogers |
| elastomer | aluminum trihydrate filler, addition cured | | Corporation |
| Polychloroprene | Commercial grade rubber sheet; Shore A 30 durometer; | | E. James |
| layer | thickness 0.787 mm; elongation 350%, tensile modulus | | |
| | 2,000 psi (13,790 kPa), water permeation 2.68 (water | | |
| | vapor) and 0.944 (liquid) g mm/m² · day | | |
| Acrylic adhesive | Acrylic double-sided adhesive | 2178SL | Flexconn |
| Multipurpose | Multipurpose adhesive | Super 77 | 3M |
| adhesive | | | |

### Example 1

A surface of two silicone flexible foam layers were coated with a coating including 66 weight percent aluminum hydroxide in silicone elastomer to a thickness of 5.8 mm and cured in a convective oven at 85° C. for 15 minutes. Each of the silicone flexible foam layers was adhered to opposing surfaces of a polychloroprene layer with acrylic adhesive to form a thermally insulating multilayer layer with the coated surfaces of the silicone flexible foam layers facing outward.

### Example 2

A pyrogel layer was adhered on a surface of a polyurethane flexible foam layer with multipurpose adhesive.

### Example 3

A silicone flexible foam layer was adhered on opposing surfaces of a polychloroprene layer and the layered composite was immersed in water at 70° C. for 24 hours to imbibe the water into the silicone flexible foam layer, as the high heat capacity of liquid water was beneficial towards significantly delaying heat transfer from one surface to the other.

### Thermal Runaway Simulation

The sample of each of Examples 1-3 was evaluated in a test designed to simulate the high temperatures of a thermal runaway event. FIG. 7 illustrates a hot plate test apparatus 5000 used. A thermally insulating multilayer sheet 102 was disposed directly on hot plate 700 set to 550° C. The pyrogel surface of Example 2 was placed on the hotplate. A 12.7 mm mica plate cell analog 900 was placed on the top surface of the thermally insulating multilayer sheet 102. A thermocouple sensor 800 was inserted into a hole drilled in the mica plate cell analog 900 to dispose the thermocouple sensor 800 on the top surface of the thermally insulating multilayer sheet 102. Heat from the hot plate diffuses into the sample, and generates water vapor when reaching approximately 220° C.

FIG. 8 shows the temperature increase detected by the thermocouple for each sample measured over time. The thermally insulating multilayer sheet of Example 1 provided better thermal protection to the opposing surface as compared to Examples 2 and 3. After 10 minutes, the measured temperature for Example 1 was lower than that for Examples 2 and 3, respectively. For electric vehicle battery applications, technical feasibility can be determined by the time to reach 150° C., which is desirably as long as possible, for example at least 10 minutes. Even over a prolonged exposure of 20 minutes, the opposing surface of the thermally insulating multilayer sheet of Example 1 was only 140° C., and did not reach 150° C.

Without being bound by theory, it is believed that the excellent results produced by Example 1 are due to different mechanisms working in concert. First, in all examples, the aluminum hydroxide, polychloroprene, silicone foam, polyurethane foam, and pyrogel layers all provide a barrier to heat conduction. Heat conduction is slower in Example 2 than in Example 3. When a flame retardant layer (i.e., aluminum hydroxide) is present, heat is further absorbed due to the heat capacity of the aluminum hydroxide and the heat of water vapor production from the aluminum hydroxide. However, water vapor production results in increased heat convection through porous materials (i.e., foam). The nonporous polychloroprene layer blocks the water vapor and hot gasses, thereby providing improved thermal resistance to the multilayer sheet. In particular, water vapor produced on the heated surface of the thermally insulating multilayer sheet of Example 1 is constrained by the polychloroprene layer.

Set forth below are non-limiting aspects of the present disclosure.

Aspect 1: A thermally insulating multilayer sheet for preventing thermal runaway, comprising: a nonporous elastomeric barrier layer having a first and a second opposed surface; a flexible foam layer disposed on the first surface of the barrier layer; and a flame retardant component, wherein the flame retardant component is distributed within the flexible foam layer, contacts a surface of the flexible foam layer, or both.

Aspect 2: The thermally insulating multilayer sheet of Aspect 1, further comprising an additional flexible foam layer disposed on the second surface of the nonporous elastomeric barrier layer.

Aspect 3: The thermally insulating multilayer sheet of Aspect 1 or Aspect 2, wherein the nonporous elastomeric barrier layer comprises an elastomer having a permeability coefficient for water of less than 20 g-mm per m² per day, or less than 10 g-mm per m² per day, or less than 5 g-mm per m² per day, each measured at 25° C. and 1 atmosphere; a tensile stress at 100% elongation of 0.5 to 15 megaPascals measured at 21° C. in accordance with ASTM 412; or a combination thereof.

Aspect 4: The thermally insulating multilayer sheet of any one of the foregoing Aspects, wherein the nonporous elastomeric barrier layer has a thickness of 0.25 to 1 millimeters or 0.4 to 0.8 millimeters.

Aspect 5: The thermally insulating multilayer sheet of any one of the foregoing Aspects, wherein the nonporous elastomeric barrier layer comprises an acrylic rubber, butyl rubber, halogenated butyl rubber, epichlorohydrin rubber, ethylene-acrylic rubber, ethylene-butyl acrylic rubber, ethylene-diene rubber, ethylene-propylene rubber, ethylene-propylene-diene monomer rubber, ethylene-vinyl acetate, fluoroelastomer, perfluoroelastomer, polyamide, polybutadiene, polychloroprene, polyolefin rubber, polyisoprene, polysulfide rubber, natural rubber, nitrile rubber, low density polyethylene, polypropylene, thermoplastic polyurethane elastomer, silicone rubber, fluorinated silicone rubber, styrene-butadiene, styrene-isoprene, vinyl rubber, or a combination thereof.

Aspect 6: The thermally insulating multilayer sheet of any one of the foregoing Aspects, wherein the nonporous elastomeric barrier layer comprises ethylene-propylene-diene monomer rubber, polychloroprene, or a combination thereof.

Aspect 7: The thermally insulating multilayer sheet of any one of the foregoing Aspects, wherein each flexible foam layer independently has a compression force deflection of 0.2 to 125 pounds per square inch (1 to 862 kilopascals), or 0.25 to 20 pounds per square inch (1.7 to 138 kilopascals), or 0.5 to 10 pounds per square inch (3.4 to 68.90.5 kilopascals), each at 25% deflection and determined in accordance with ASTM D3574-17; a compression set of 0 to 15%, or 0 to 10%, or 0 to 5%, determined in accordance with ASTM D 3574-95 Test D at 70° C.; a density of 5 to 65 pounds per cubic foot (80 to 1,041 kilograms per cubic meter), or 6 to 20 pounds per cubic foot (96 to 320 kilograms per cubic meter), or 8 to 15 pounds per cubic foot (128 to 240 kilograms per cubic meter); or a combination thereof.

Aspect 8: The thermally insulating multilayer sheet of any one of the foregoing Aspects, wherein each flexible foam layer independently has a thickness of 0.1 to 5 millimeters, 1 to 3 millimeters, or 1.5 to 2.5 millimeters.

Aspect 9: The thermally insulating multilayer sheet of any one of the foregoing Aspects, wherein each flexible foam layer independently comprises a silicone, a polyurethane, an aerogel, an ethylene-vinyl acetate, an ethylene-methyl acrylate, an ethylene-butyl acrylate, or a combination thereof.

Aspect 10: The thermally insulating multilayer sheet of any one of the foregoing Aspects, wherein each flexible foam layer independently comprises a reinforcing material.

Aspect 11: The thermally insulating multilayer sheet of Aspect 9, wherein the reinforcing material is a reinforcing particulate material comprising carbon black, glass, glass microspheres, lignin, a particulate metal oxide, polyhedral oligomeric silsesquioxane, mica, quartz, silica, talc, polyhedral oligomeric silsesquioxane, or a combination thereof; a reinforcing fiber material, wherein fibers of the reinforcing fiber material comprise polyester, oxidized polyacrylonitrile, carbon, silica, polyaramid, polycarbonate, polyolefin, rayon, nylon, fiberglass, high density polyolefin, ceramic, acrylics, fluoropolymer, polyurethane, polyamide, polyimide, or a combination thereof or a combination of the reinforcing particulate material and the reinforcing fiber material.

Aspect 12: The thermally insulating multilayer sheet of any one of the foregoing Aspects, wherein the flame retardant component is a particulate within a pore of the flexible foam layer.

Aspect 13: The thermally insulating multilayer sheet of any one of the foregoing Aspects, wherein the flame retardant component is a flame retardant layer contacting a surface of the flexible foam layer.

Aspect 14: The thermally insulating multilayer sheet of Aspect 13, wherein the flame retardant layer has a thickness of 0.1 to 2 millimeters, or 0.5 to 1.5 millimeters, or 0.8 to 1.1 millimeters.

Aspect 15: The thermally insulating multilayer sheet of Aspect 13 or 14, wherein the flame retardant layer comprises boehmite, aluminum hydroxide, aluminum trihydrate, magnesium hydroxide, an intumescent material, or a combination thereof.

Aspect 16: The thermally insulating multilayer sheet of any one of Aspects 13 to 15, wherein the flame retardant layer further comprises a char-forming agent, preferably an ammonium polyphosphate, boehmite, cellulose, clay nanocomposite, cyanurate, expandable graphite, huntite, hydromagnesite, lignin, lignosulfonate, melamine, nanosilica, pentaerythritol, zinc borate, or a combination thereof.

Aspect 17: The thermally insulating multilayer sheet of any one of Aspects 13 to 16, wherein the flame retardant layer further comprises a polymer binder, preferably a silicone, a polyurethane, an ethylene-vinyl acetate, an ethylene-methyl acrylate, an ethylene-butyl acrylate, or a combination thereof.

Aspect 18: The thermally insulating multilayer sheet of any one of the foregoing Aspects, wherein the flame retardant component is distributed within the flexible foam layer, and wherein the flame retardant component comprises aluminum trihydrate, borax, hydrous sodium silicate, magnesium hydroxide, magnesium carbonate hydroxide pentahydrate, magnesium phosphate tribasic octahydrate, or zinc borate, preferably at least two of aluminum trihydrate, borax, hydrous sodium silicate, magnesium hydroxide, magnesium carbonate hydroxide pentahydrate, magnesium phosphate tribasic octahydrate, or zinc borate.

Aspect 19: The thermally insulating multilayer sheet of Aspect 18, wherein the flame retardant component distributed within the matrix of the flexible foam layer further comprises an organic flame retardant.

Aspect 20: The thermally insulating multilayer sheet of any one of the foregoing Aspects, having a thermal conductivity of 0.01 to 0.09 watts per meter kelvin at 23° C.; a thickness of 0.2 to 30 millimeters, or 0.2 to 20 millimeters, or 0.2 to 15 millimeters, or 0.2 to 10 millimeters, or 0.5 to 10 millimeters, or 0.5 to 8 millimeters, or 1 to 6 millimeters; a density of 6 to 30 pounds per cubic foot (96 to 481 kilograms per cubic meter), or 10 to 25 pounds per cubic foot (160 to 400 kilograms per cubic meter), or 15 to 20 pounds per cubic foot (240 to 320 kilograms per cubic meter); or a combination thereof.

Aspect 21: An electrochemical cell, comprising the thermally insulating multilayer sheet of any one the foregoing Aspects disposed on at least a portion of surface of the electrochemical cell.

Aspect 22: The electrochemical cell of Aspect 21, wherein the thermally insulating multilayer sheet is disposed on at least two surfaces of the electrochemical cell.

Aspect 23: The electrochemical cell of Aspect 21 or 22, wherein the electrochemical cell comprises a prismatic cell, pouch cell, or cylindrical cell, preferably a pouch cell.

Aspect 24: An unconnected array, comprising at least two of the electrochemical cells of any one of Aspects 21 to 23.

Aspect 25: A battery, comprising the electrochemical cell of any one of Aspects 21 to 23 or the unconnected array of Aspect 24.

Aspect 26: The battery of Aspect 25, further comprising a battery case at least partially enclosing the electrochemical cell or the unconnected array.

The compositions, methods, and articles can alternatively comprise, consist of, or consist essentially of, any appropriate materials, steps, or components herein disclosed. The compositions, methods, and articles can additionally, or alternatively, be formulated so as to be devoid, or substantially free, of any materials (or species), steps, or components, that are otherwise not necessary to the achievement of the function or objectives of the compositions, methods, and articles.

The terms “a” and “an” do not denote a limitation of quantity, but rather denote the presence of at least one of the referenced items. The term “or” means “and/or” unless clearly indicated otherwise by context. Reference throughout the specification to “an aspect”, “another aspect”, and so forth, means that a particular element (e.g., feature, structure, step, or characteristic) described in connection with the aspect is included in at least an aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present. When an element is referred to as “contacting” or “contacts” another element, there are no intervening elements present.

Unless specified to the contrary herein, all test standards are the most recent standard in effect as of the filing date of this application, or, if priority is claimed, the filing date of the earliest priority application in which the test standard appears.

The endpoints of all ranges directed to the same component or property are inclusive of the endpoints, are independently combinable, and include all intermediate points and ranges. For example, ranges of “up to 25 wt %, or 5 to 20 wt %” is inclusive of the endpoints and all intermediate values of the ranges of “5 to 25 wt %,” such as 10 to 23 wt %, etc.). The terms “first,” “second,” and the like, “primary,” “secondary,” and the like, as used herein do not denote any order, quantity, or importance, but rather are used to distinguish one element from another. The term “combination thereof” is open, and means that the list is inclusive of each element individually, as well as combinations of two or more elements of the list, and combinations of at least one element of the list with like elements not named. Also, the term “combination” is inclusive of blends, mixtures, alloys, reaction products, and the like.

Unless defined otherwise, technical and scientific terms used herein have the same meaning as is commonly understood by one of skill in the art to which this disclosure belongs.

All cited patents, patent applications, and other references are incorporated herein by reference in their entirety. However, if a term in the present application contradicts or conflicts with a term in the incorporated reference, the term from the present application takes precedence over the conflicting term from the incorporated reference.

In the drawings, the widths and thicknesses of layers and regions are exaggerated for clarity of the specification and convenience of explanation. Like reference numerals in the drawings denote like elements.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

While particular aspects have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

1. A thermally insulating multilayer sheet for preventing thermal runaway in a battery, the multilayer sheet comprising:
a nonporous elastomeric barrier layer having a first and a second opposed surface;
a flexible foam layer disposed on the first surface of the barrier layer; and
a flame retardant component, wherein the flame retardant component
is distributed within the flexible foam layer,
contacts a surface of the flexible foam layer,
or both.

2. The thermally insulating multilayer sheet of claim 1, further comprising an additional flexible foam layer disposed on the second surface of the nonporous elastomeric barrier layer.

3. The thermally insulating multilayer sheet of claim 1, wherein the nonporous elastomeric barrier layer comprises an elastomer having
a permeability coefficient for water of less than 20 g-mm per m² per day, measured at 25° C. and 1 atmosphere;
a tensile stress at 100% elongation of 0.5 to 15 megaPascals measured at 21° C. in accordance with ASTM 412; or
a combination thereof.

4. The thermally insulating multilayer sheet of claim 1, wherein the nonporous elastomeric barrier layer has a thickness of 0.25 to 1 millimeters.

5. The thermally insulating multilayer sheet of claim 1, wherein the nonporous elastomeric barrier layer comprises an acrylic rubber, butyl rubber, halogenated butyl rubber, epichlorohydrin rubber, ethylene-acrylic rubber, ethylene-butyl acrylic rubber, ethylene-diene rubber, ethylene-propylene rubber, ethylene-propylene-diene monomer rubber, ethylene-vinyl acetate, fluoroelastomer, perfluoroelastomer, polyamide, polybutadiene, polychloroprene, polyolefin rubber, polyisoprene, polysulfide rubber, natural rubber, nitrile rubber, low density polyethylene, polypropylene, thermoplastic polyurethane elastomer, silicone rubber, fluorinated silicone rubber, styrene-butadiene, styrene-isoprene, vinyl rubber, or a combination thereof.

6. The thermally insulating multilayer sheet of claim 1, wherein the nonporous elastomeric barrier layer comprises ethylene-propylene-diene monomer rubber, polychloroprene, or a combination thereof.

7. The thermally insulating multilayer sheet of claim 1, wherein each flexible foam layer independently has
a compression force deflection of 0.2 to 125 pounds per square inch (1 to 862 kilopascals), at 25% deflection and determined in accordance with ASTM D3574-17;
a compression set of 0 to 15%, determined in accordance with ASTM D 3574-95 Test D at 70° C.;
a density of 5 to 65 pounds per cubic foot (80 to 1,041 kilograms per cubic meter; or
a combination thereof.

8. The thermally insulating multilayer sheet of claim 1, wherein each flexible foam layer independently has a thickness of 0.1 to 5 millimeters.

9. The thermally insulating multilayer sheet of claim 1, wherein each flexible foam layer independently comprises a silicone, a polyurethane, an aerogel, an ethylene-vinyl acetate, an ethylene-methyl acrylate, an ethylene-butyl acrylate, or a combination thereof.

10. The thermally insulating multilayer sheet of claim 1, wherein each flexible foam layer independently comprises a reinforcing material.

11. The thermally insulating multilayer sheet of claim 9, wherein the reinforcing material is
a reinforcing particulate material comprising carbon black, glass, glass microspheres, lignin, a particulate metal oxide, polyhedral oligomeric silsesquioxane, mica, quartz, silica, talc, polyhedral oligomeric silsesquioxane, or a combination thereof;
a reinforcing fiber material, wherein fibers of the reinforcing fiber material comprise polyester, oxidized polyacrylonitrile, carbon, silica, polyaramid, polycarbonate, polyolefin, rayon, nylon, fiberglass, high density polyolefin, ceramic, acrylics, fluoropolymer, polyurethane, polyamide, polyimide, or a combination thereof; or
a combination of the reinforcing particulate material and the reinforcing fiber material.

12. The thermally insulating multilayer sheet of claim 1, wherein the flame retardant component is a particulate within a pore of flexible foam layer.

13. The thermally insulating multilayer sheet of claim 1, wherein the flame retardant component is a flame retardant layer contacting a surface of the flexible foam layer.

14. The thermally insulating multilayer sheet of claim 13, wherein the flame retardant layer has a thickness of 0.1 to 2 millimeters.

15. The thermally insulating multilayer sheet of claim 13, wherein the flame retardant layer comprises aluminum hydroxide, aluminum trihydrate, boehmite, magnesium hydroxide, an intumescent material, or a combination thereof.

16. The thermally insulating multilayer sheet of claim 13, wherein the flame retardant layer further comprises a char-forming agent.

17. The thermally insulating multilayer sheet of claim 13, wherein the flame retardant layer further comprises a polymer binder.

18. The thermally insulating multilayer sheet of claim 1, wherein the flame retardant component is distributed within the matrix of the flexible foam layer, and wherein the flame retardant component comprises
aluminum trihydrate, borax, hydrous sodium silicate, magnesium hydroxide, magnesium carbonate hydroxide pentahydrate, magnesium phosphate tribasic octahydrate, or zinc borate.

19. The thermally insulating multilayer sheet of claim 18, wherein the flame retardant component distributed within the matrix of the flexible foam layer further comprises an organic flame retardant.

20. The thermally insulating multilayer sheet of claim 1, having
a thermal conductivity of 0.01 to 0.09 watts per meter kelvin at 23° C.;
a thickness of 0.2 to 30 millimeters;
a density of 6 to 30 pounds per cubic foot (96 to 481 kilograms per cubic meter); or
a combination thereof.

21. An electrochemical cell, comprising
the thermally insulating multilayer sheet of claim 1 disposed on at least a portion of surface of the electrochemical cell.

22. The electrochemical cell of claim 21, wherein the thermally insulating multilayer sheet is disposed on at least two surfaces of the electrochemical cell.

23. The electrochemical cell of claim 21, wherein the electrochemical cell comprises a prismatic cell, pouch cell, or cylindrical cell.

24. An unconnected array, comprising at least two of the electrochemical cells of claim 21.

25. A battery, comprising the electrochemical cell of claim 21.

26. The battery of claim 25, further comprising a battery case at least partially enclosing the electrochemical cell.
